(19) United States
(12) Patent Application Publication
(10) Pub. No.: US 2025/0368550 A1
(43) Pub. Date: Dec. 4, 2025

(54) MITIGATION AND RECOVERY OF DEGRADED DEVICE EFFICIENCY IN WATER ELECTROLYZERS CAUSED BY IMPURITIES

(71) Applicant: EVOLOH, INC., Palo Alto, CA (US)

(72) Inventors: Ashutosh DIVEKAR, Palo Alto, CA (US); Sebastian Felipe MARIN QUIROS, Menlo Park, CA (US)

(21) Appl. No.: 19/223,573

(22) Filed: May 30, 2025

Related U.S. Application Data
(60) Provisional application No. 63/655,862, filed on Jun. 4, 2024.

(51) Int. Cl. C02F 1/42; B01J 43/00; B01J 49/09; C02F 1/00; C02F 1/28; C02F 1/70; C02F 101/22; C25B 15/02; C25B 15/08

(52) U.S. Cl. CPC C02F 1/42; B01J 43/00; B01J 49/09; C02F 1/001; C02F 1/281; C02F 1/705; C25B 15/02; C25B 15/085; C02F 2001/427; C02F 2101/22; C02F 2303/16

(57) ABSTRACT

An impurity removal system for process water for an electrolytic cell.

### INCORPORATION BY REFERENCE OF RELATED PATENT APPLICATIONS

This application is based upon and claims the benefit of priority under 35 U.S.C. § 119(e) to U.S. Provisional Application No. 63/655,862, filed Jun. 4, 2024, the entire contents of all of which are incorporated herein by reference in their entirety.

### FIELD OF THE INVENTION

The present application relates to mitigating and recovering device efficiency deterioration, particularly for electrolyzer devices, including innovative materials and approaches to stack operation, filters for selective removal of impurities, and strategies to recover cell efficiency.

### BACKGROUND

Water electrolysis, also known as “water splitting,” forms oxygen gas (O₂) and hydrogen gas (H₂) by decomposing liquid water (H₂O). Gas evolution happens when an electric current is flown through a device at a voltage of at least 1.23V applied across an anode and a cathode. Hydrogen and oxygen gases are evolved at the cathode and anode, respectively. Hydrogen gas has been described as a fuel for a cleaner future that could be used in transportation as well as industrial applications, such as the Haber-Bosch process to generate ammonia. Oxygen gas finds applications as an oxidizing reagent, or a component of breathable air used by astronauts and cosmonauts residing at the International Space Station (ISS) for maintaining their life-supporting oxygen supply.

The two primary water electrolysis approaches currently commercialized include alkaline electrolysis and proton exchange membrane (PEM) electrolysis. Alkaline electrolyzers are less efficient than PEM electrolyzers and rely on liquid electrolytes, which are often corrosive. The initial capital expenditure and balance of plant (supporting components and auxiliary systems) of these systems are expensive, requiring a larger plant to produce the same material output. PEM electrolyzers achieve higher current densities than alkaline electrolyzers, but they have drawbacks. Although they can be operated using pure water with no added electrolytes, they operate in acidic environments, which require expensive anode and cathode catalyst materials (e.g., platinum-group metal electrodes) and expensive bipolar plates, such as titanium. Therefore, the initial capital expenditure associated with PEMs is, unfortunately, also significant. Additionally, PEM electrolyzers require high water purity throughout the operation, which increases the cost of balance of the plant.

Anion exchange membrane electrolyzers (AEMELs), which can operate using relatively inexpensive polymeric membrane materials and low-cost non-precious metal catalysts, have the potential to lower the capital expenditure of an electrolyzer unit significantly. Although this technology has great potential, device durability remains the biggest hurdle for mass-scale commercialization. A traditional anion exchange membrane electrolyzer exhibits poor durability when operated with water containing even trace impurities; as such, impurities degrade the cell components in the device, impacting stack durability and increasing the cost of hydrogen production. Stack operation using stainless steel components is also very challenging due to generated hazardous ions such as hexavalent chromium from stack operation. (See, e.g. Todoroki et al., Stainless Steel Anode for Alkaline Water Electrolysis, 64 Metallurgy and Advanced Catalytic Materials 2376 (2023) and Moranchell at al., Electrodes Modified with Ni Electrodeposition Decrease Hexavalent Chromium Generation in an Alkaline Electrolysis Process, 45 Int. J. of Hydrogen Energy 13638 (2020)). Unfortunately, the typical electrolyzer lifespan with impurities within circulating water is only approximately a few 100s of hours, which is insufficient for widespread commercial deployment.

### SUMMARY

Recognizing the benefits and current challenges associated with AEMELs, the inventors of the present application have invented new approaches to mitigate performance loss arising from water impurities when such water-containing impurities are used in an electrolyzer. Thus, the inventors have developed novel electrolyzer designs, methods for producing electrolyzer materials, methods for incorporating these materials in electrolyzers, and strategies to recover lost performance due to impurities in the water electrolyzer operation.

Thus, in one aspect, this application provides designs for electrolyzers that exhibit excellent durability and high current density in electrochemical applications such as electrolysis (of water, carbon dioxide, etc.), fuel cells, electrodialysis, etc. As discussed in more detail herein, the embodiments of the present application directly address the need to improve device durability in AEMELs. Embodiments of the present application enable water electrolyzers using anionic exchange membranes capable of operating with a range of temperatures (0-160° C.) as well as a range of electrolyte types (KOH, K₂CO₃, NaOH, Na₂CO₃, KHCO₃, NaHCO₃, etc.) for at least 2000 hours, a significant increase with respect to the state of the art. Embodiments of the present application also enable the water electrolyzers made from stainless steel components capable of operating safely without exceeding a permissible concentration of hazardous hexavalent chromium (an “occupational carcinogen” according to the U.S. Centers for Disease Control) in the circulating water.

In one aspect, the present application provides novel methods, devices, and systems for mitigating impurities in water that impact cell efficiency and durability. According to some embodiments, the impurities removal components depicted in FIGS. 1, 2, and 3 selectively remove unwanted impurities from process water without changing the desired process water composition.

The present application also provides novel methods for conditioning or regenerating impurity removal components for extended use or reuse. According to some embodiments, such methods will ensure that the desired process water composition is maintained throughout the operation until the removal capacity drops. The methods discussed will enable the regeneration of components to be reused to maintain the desired process water composition. The methods discussed will also enable the safe disposal of hexavalent chromium leached from the electrolyzer.

In one aspect, the present application provides novel methods, devices, and systems for recovering cell efficiency reduced by decay caused by impurities. According to some embodiments, such methods, devices, and systems leverage changes in operating current density and/or type of fluid flow through the stack.

Further objects, features, and advantages of the present application will become apparent from the detailed description of preferred embodiments, which is set forth below when considered together with the drawing figures.

### BRIEF DESCRIPTION OF THE DRAWINGS

FIG. 1 depicts an embodiment of an electrolyzer device containing a stack of N cells and embodiments of the components discussed herein.

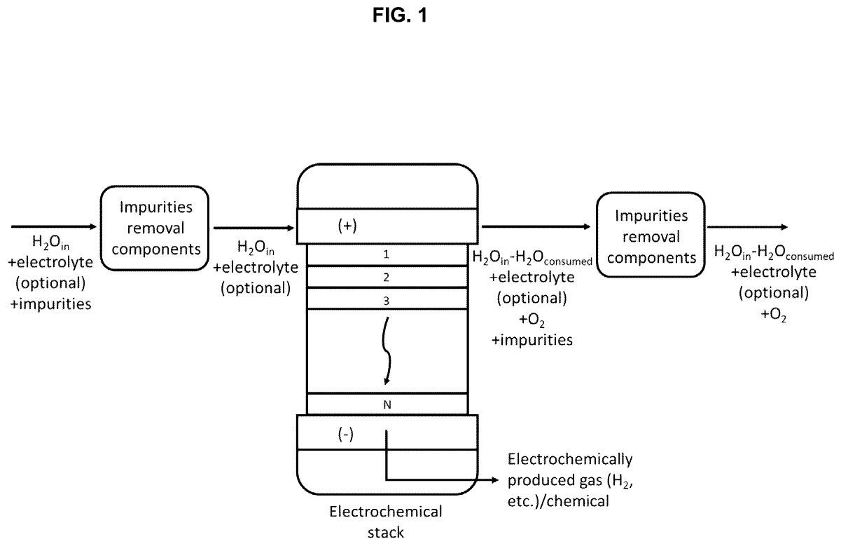

FIG. 2 depicts an embodiment of an electrolyzer device containing a stack of N cells and embodiments of the components discussed herein.

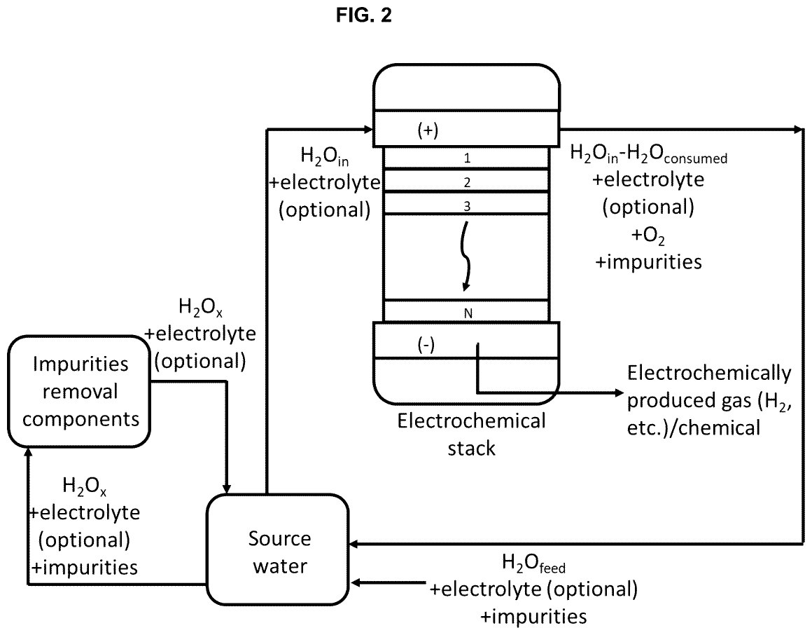

FIG. 3 depicts an embodiment of an electrolyzer device containing a stack of N cells and embodiments of the components discussed herein.

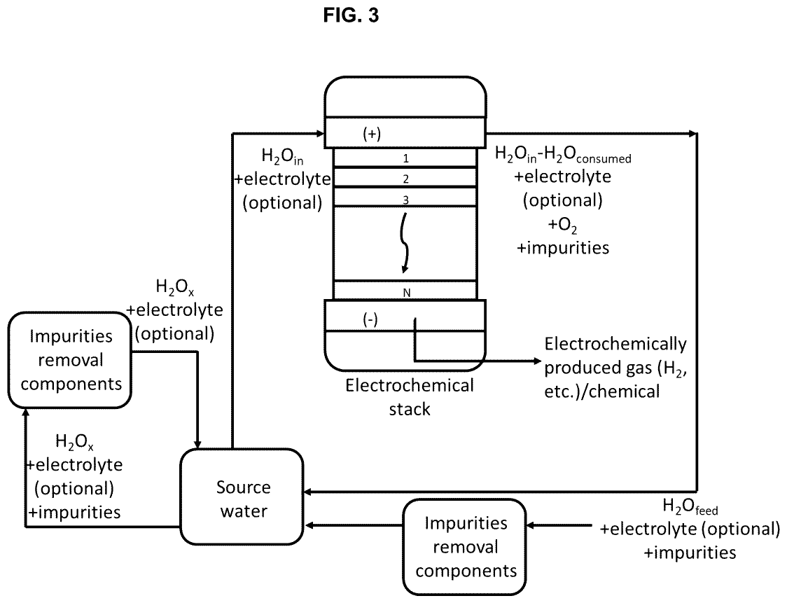

FIG. 4 depicts an embodiment of an impurity removal component containing a filter assembly discussed herein.

FIG. 5 depicts an embodiment of a filter assembly consisting of a matrix of multiple filters in parallel and/or in series discussed herein.

FIG. 6 depicts a schematic of one embodiment of an insoluble solids filter according to the present application.

FIG. 7 depicts an embodiment of a soluble solute(s) filter packed with a polymeric resin media.

FIG. 8 depicts an embodiment of a filter consisting of a matrix of multiple filters in parallel and/or in series discussed herein.

FIG. 9 depicts an embodiment of a method to condition the soluble solute(s) filter containing ion exchange resin media.

FIG. 10 depicts average of cell voltages as a function of time in Example 1 as discussed in the example.

FIG. 11 depicts average of cell voltages as a function of time in Example 2 as discussed in the example.

FIG. 12 depicts average of cell voltages as a function of time in Example 3 as discussed in the example.

FIG. 13 depicts average of cell voltages as a function of time in Example 3. as discussed in the example

### DETAILED DESCRIPTION

In one aspect, the inventors of the present application have invented novel impurities removal components, methods for producing such components, and methods for incorporating such components in electrolyzers, including water electrolyzers. In another aspect, the inventors of the present application have developed components that selectively remove impurities in the feed as well as outlet water containing optional electrolyte, which enables excellent durability and high current density in electrochemical applications such as electrolysis (of water, carbon dioxide, etc.), fuel cells, electrodialysis, etc. As discussed in more detail herein, embodiments of the impurities removal components of the present application directly address the need to improve device durability and safety in electrolyzers, such as AEMELs.

### Definitions

As used herein, the following definitions will apply unless otherwise indicated.

In the context of the present application, the term “resin” means an insoluble matrix of a solid generally in the form of small microbeads fabricated from an organic polymer matrix.

In the context of the present application, the term “anion exchange resin” means resins that contain basic chemical groups for exchanging anions.

In the context of the present application, the term “cation exchange resin” means resins that contain acidic chemical groups for exchanging cations.

In the context of the present application, the term “filter” means a device/component used to remove unwanted impurities from fluids.

In the context of the present application, the term “fouling” means accumulation of unwanted material on solid surfaces of stack components.

In the context of the present application, the term “anti-foulant” means a substance or a fluid used to clean a fouled surface.

In the context of the present application, the term “solute” means a substance such as an ionic salt dissolved in a solvent such as water.

### Impurity Removal Components

In one aspect, the present application provides novel impurity removal components for use in electrolytic cells, preferably water electrolyzers. In one embodiment, the impurity removal components include one or more filters designed for selectively removing impurities from process water used in electrochemical devices. Preferably, a filter according to the present application can remove one or more solid impurities, wherein the solid impurities can be soluble (solutes) or insoluble (suspended solids) in the process water. Embodiments of the filters of the present application are compatible at a wide range of process water temperatures and dissolved electrolyte types and concentrations.

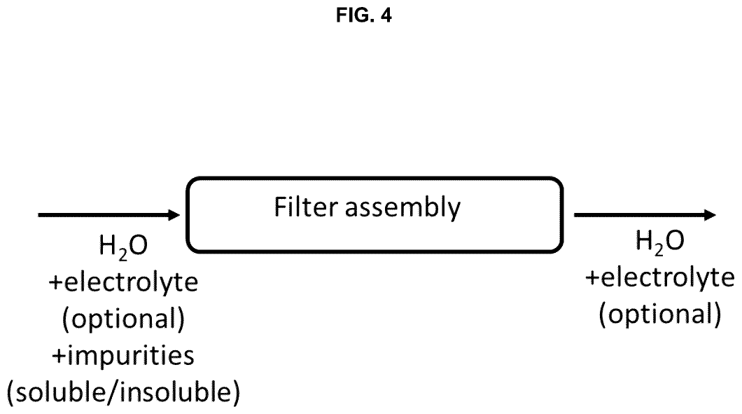

An exemplary block diagram of one embodiment of a filter system according to the present application is shown in FIG. 4. The block diagram depicted in FIG. 4 shows process water containing an optional electrolyte having impurities entering a filter assembly on an inlet side of the filter assembly. The impurities in the process water may be soluble, insoluble, or a combination of soluble and insoluble impurities. Examples of solutes include but are not limited to Ca²⁺, Mg²⁺, Cl, Br, F, etc. Examples of insoluble impurities include but are not limited to Silica, silt, insoluble organics, etc. The filter assembly filters the impurities from the process water such that an outlet stream containing process water and electrolyte exits the filter assembly. Although the outlet stream is depicted as omitting impurities, the outlet stream may contain trace impurities as compared to the impurity concentration of the inlet stream. According to embodiments of the present application, the outlet stream contains less than 1% of the impurity concentration of the inlet stream. Preferably, the outlet stream contains less than 0.1% or less than 0.01% of the impurity concentration of the inlet stream. More preferably, the outlet stream contains less than 0.001% or less than 0.0001% impurities.

The filter assemblies of the present application may be arranged upstream of the process water inlet of the water electrolyzer or downstream of the process water outlet of the water electrolyzer, or both. In some embodiments, multiple filter assemblies may be used. The filter assemblies may be arranged in parallel or series, or both.

A filter assembly according to the present application preferably contains multiple filters arranged in order or disorder. In the context of the present application, a filter assembly arranged in disorder if such assembly contains a plurality of filters without a repeating pattern of arrangement. In one embodiment, an ordered filter assembly, according to the present application, contains a plurality of filters arranged in parallel and/or in series.

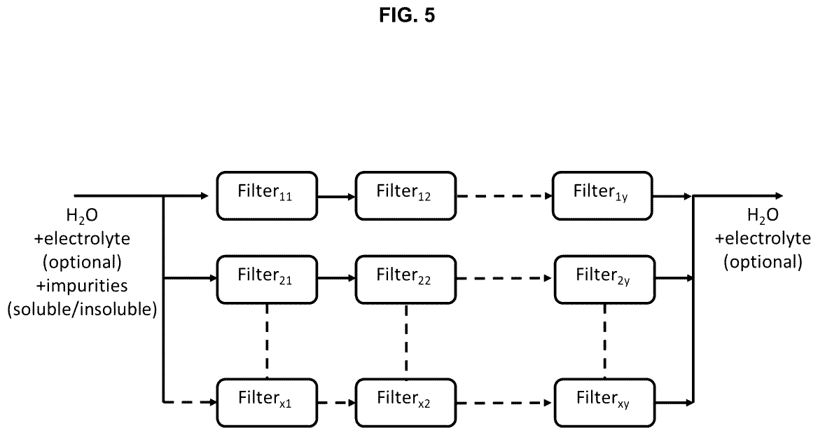

A block diagram of an embodiment of a filter assembly according to the present application is shown in FIG. 5. FIG. 5 shows a filter assembly comprising a plurality of filters enumerated as Filter₁₁ to Filter_{xy}, wherein x and y are integers ranging from 1 to 10,0000. Although the block diagram depicts filters arranged in an array having both x and y directions, the spatial orientation of the filters need not necessarily correspond to the block diagram. In other words, the filters may or may not be spatially arranged in a regular array. As with FIG. 4 above, FIG. 5 also depicts process water containing an optional electrolyte having impurities entering a filter assembly on an inlet side of the filter assembly, and an outlet stream omitting impurities. As described above with respect to FIG. 5, trace impurities may be present in the outlet stream.

It will be apparent to one of ordinary skill in the art that the embodiments of FIGS. 4 and 5 may include different types of filters, as discussed below.

### Types of Filters

In an electrolyzer, process water will typically contain two classes of impurities: insoluble solids and soluble solute(s). Filter systems according to the present application thus include at least one and preferably at least two types of filters: an insoluble solids filter; and a soluble solute(s) filter. As discussed previously, filter systems according to the present application may contain a plurality of each type of filter. For example, with respect to the array of filters shown in FIG. 5, certain filters in the array may be insoluble solids filters and other filters may be soluble solute filters.

According to embodiments of the present application, an insoluble solids filter is a component that reduces the concentration of insoluble solids, preferably reducing the concentration of these impurities in process water. An insoluble solids filter may contain a filter housing and a filter media. Preferably, an insoluble solids filter operates on the principles of size exclusion theory. The housing preferably comprises a material that is resistant to alkaline chemicals such as polypropylene, etc. Preferably, the filter media geometry consists of a mesh, foam, paper, packed media, resins etc. Preferably, the material of construction of the filter media could be metallic, polymeric, or ceramic. In some embodiments, the insoluble solids filter comprises a string or fiber filter, a wound filter, pleated filter, screen filter, sand filter, cartridge filter, or bag filter. In a preferred embodiment, a soluble solids filter is a cartridge filter.

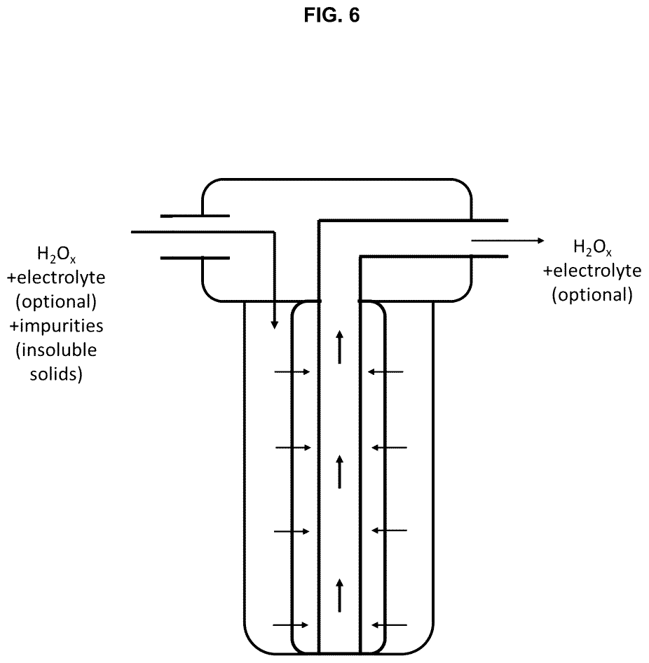

FIG. 6 depicts a schematic of one embodiment of an insoluble solids filter according to the present application comprising a cartridge filter. Process water containing insoluble solids enters the cartridge at an inlet and flows axially inside of a cartridge body adjacent to a filter media. The media may comprise any media described in the present application. The process water may optionally contain electrolyte, but a person of ordinary skill in the art would understand such electrolyte is not required for operation of the insoluble solids filter. The process water passes through the filter media, which filters the insoluble solids. Process water substantially free of insoluble solids flows axially inside the filter media and out a filter outlet.

In another embodiment, the insoluble solids filter comprises a membrane filter. In one embodiment, the insoluble solids filter comprises a sedimentation tank. In one embodiment, the insoluble solids filter comprises a gravity filter. In one embodiment, the insoluble solids filter comprises as suction filter. In one embodiment, the insoluble solids filter comprises a centrifugation filter. In one embodiment, the present application includes insoluble solids filters using more than one of the foregoing approaches.

According to embodiments of the present application, a soluble solute(s) filter is a component that reduces the concentration of soluble solutes, preferably reducing the concentration of these impurities in process water. A soluble solute filter may be a filter housing and a filter media. Preferably, a soluble solute filter operates by selectively trapping a type of solute(s) within itself and, therefore, cleaning the water flowing through itself. The housing preferably comprises a material that is resistant to alkaline chemicals such as polypropylene, etc. Preferably, a filter media geometry consists of a mesh, foam, paper, packed media, resins etc. The filter media's construction material could be metallic, polymeric, ceramic, etc.

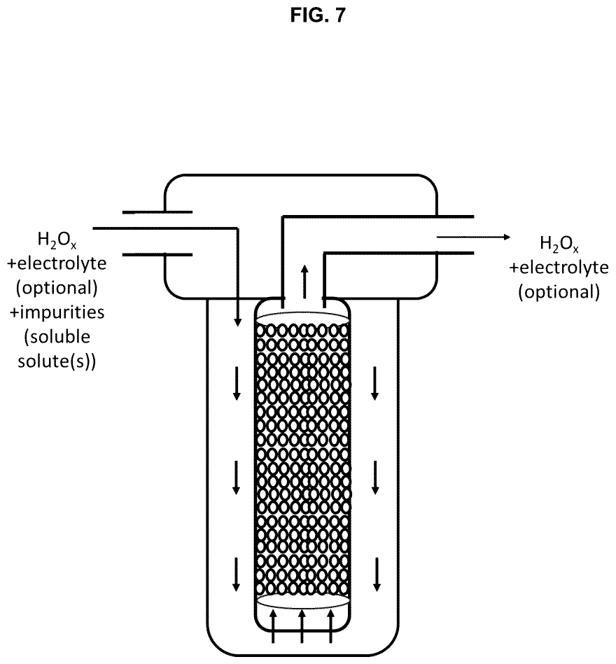

Schematics of the example of an embodiment of a soluble solute(s) filter are shown in FIG. 7. FIG. 7 depicts a schematic of one embodiment of a soluble solute(s) filter according to the present application. Process water containing soluble solutes enters an inlet of the filter and flows axially inside a housing. The process water may optionally contain electrolyte. Process water flows through a filter media comprising a polymeric resin media, which filters the soluble solute(s). Process water substantially free of insoluble solids flows out a filter outlet.

In one embodiment, the filter media in a soluble solute filter traps the soluble impurities by covalent or ionic bonding of the impurities with the media. In one embodiment, the media comprises an ion exchange resin. In one embodiment, the media comprises cation and/or anion exchange resins. In one embodiment, the filter media further comprises granulated ferric oxide. In some embodiments, the resins in the media are zwitterionic.

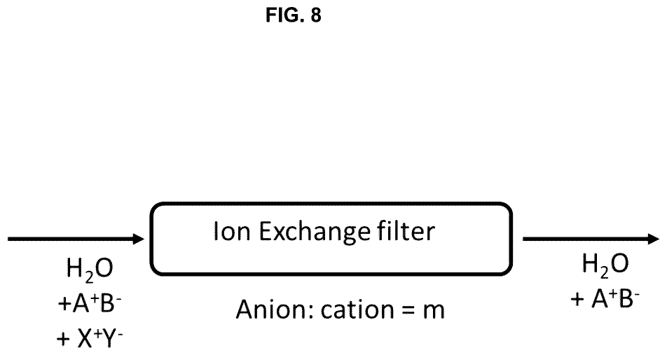

FIG. 8 shows a block diagram of a soluble solute(s) filter, depicted as an ion exchange filter. FIG. 8 depicts process water containing an electrolyte salt (A⁺B⁻) dissociated in the process water. Thus, (A⁺) is the cation of the electrolyte (Na⁺, K⁺, etc.) and (B) is the anion of the electrolyte (OH⁻, CO₃², HCO₃⁻, etc.). The process water could also contain cationic impurities (X⁺), such as Ca²⁺, Mg²⁺, Si²⁺, etc., and anionic impurities (Y), such as Br⁻, F⁻, Cl⁻, I⁻, [CrO₄]²⁻, [Cr₂O₇]²⁻. FIG. 5 depicts the filter as an ion exchange filter. In a preferred embodiment, the ion exchange filter comprises an ion exchange resin.

Preferably, the ion exchange resin is a water-insoluble polymer capable of ion exchange between the resin and the process water. In some embodiments, the hexavalent chromium [CrO₄]²⁻ gets leached out from the electrolyzer's stainless steel components, which can dissolve into process flow water and recirculate above 1.6V of operation. Hexavalent chromium has occupational hazards. The ion exchange resin will ionically bind the hexavalent chromium ion, significantly reducing the concentration in the recirculating process flow water and maintaining safe operation conditions.

In particular, the ion exchange resin preferably contains functional groups that can attract and bind ions in the process water and, in turn, release other ions into the process water. Preferably, the ion exchange resin is capable of binding cationic impurities (X⁺) and anionic impurities (Y) while releasing ions associated with the electrolyte salt (A⁺B⁻).

FIG. 8 also depicts the ion exchange resin having a ratio (m) of anionic to cationic exchange resin mass fraction. According to embodiments of the present application, this ratio can range anywhere between 0 to 1. The preferred ratio depends on the type of water electrolyzer, the materials used in the water electrolyzer, and the materials present in the associated plant that come into contact with the process water. For a some AEMELs and associated plant, the ratio is preferably between 0.25 to 0.75 or 0.4 to 0.6. For some AEMELs, at least two filters may be used, which each filter having a different ratio depending on configuration of plant. For some AEMELs and associated plant, at least two filters may be used, wherein some of the filters have a ratio of 1 and some of the filters have a ratio of 0.

According to embodiments of the present application, the ion exchange resin is a polymeric salt. According to certain embodiments, the ion exchange resin, according to the present application, contains hydrophobic as well as hydrophilic monomeric units. In some embodiments, the monomeric units may polymerize to form a random and/or block polymers. The polymers may be cross-linked or uncross-linked. The polymers within the resin may consist of cations, anions, and/or both attached to the polymer backbone with or without sidechain through a covalent bond.

For maintaining the charge neutrality, the ion exchange resins will contain mobile anions, cations, and/or both respectively. The examples of fixed cations may contain N, Co, or P elements. The resins that contain N are typically quaternary ammonium with alkyl groups such as trimethyl ammonium, triethyl ammonium, etc. The quaternary ammonium may also contain heterocyclic groups such as piperidinium, etc. In some situations, the fixed cation could also be a metal-organic molecule. The fixed anions could consist of S or C. The resins that contain S are typically called as sulfonic acids, etc. In some situations, the fixed anions could also be a metal organic such as heteropoly acids, etc.

The mobile anions may consist of OH⁻, CO₃²⁻, HCO₃⁻, etc., and the mobile cations may consist of H⁺, Na⁺, K⁺, etc.

In another embodiment, the soluble solute(s) filter may contain adsorbent resins. In some embodiments, the adsorbent resins filter phosphates, silicates, or organics from process water. In some embodiments, the adsorbent resins comprise granulated ferric oxide.

In another embodiment, the soluble solute(s) filter may contain a precipitation tank, in which ions are precipitated for removal from the process water. In some embodiments, ions are precipitated by introducing an acid or base to change the pH of the solution. In some embodiments, ions precipitate by introducing a counterion into the solution. In some embodiments, ions are precipitated via electrolysis. In certain embodiments, a precipitation tank is arranged upstream of an insoluble solids filter.

### Conditioning of Soluble Solute(s) Filter:

In some situations, filter media containing the desired exchange ions are not commercially available. Thus, in some embodiments, a filter resin is to replace the existing ions with the desired ions through ion exchange to ensure that the resins have the desired exchange ions.

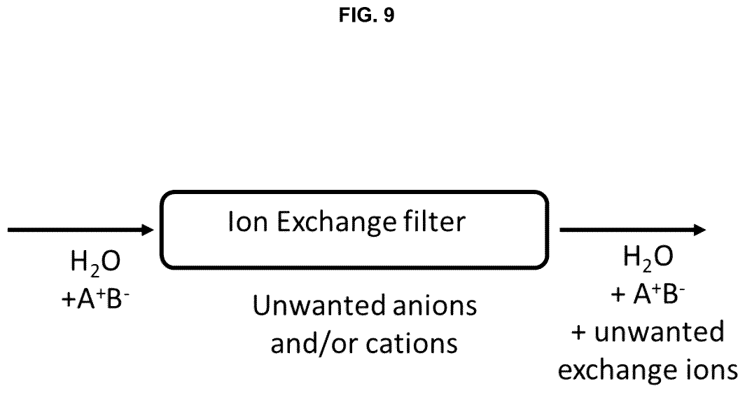

FIG. 9 depicts an embodiment of the process of conditioning the ion exchange media with desired exchange ions. According to FIG. 9, water containing a desired electrolyte (A⁺B⁻) is flowed with a sufficiently high concentration such that the unwanted exchange ions are replaced with the desired A⁺ and/or B⁻ ions. Thus, in some embodiments, (A⁺) is the cation of the electrolyte (Na⁺, K⁺, etc.), and (B) is the anion of the electrolyte (OH⁻, CO₃²⁻, HCO₃⁻, etc.). In a preferred embodiment, for example, the electrolyte is K₂CO₃ (K⁺ & CO₃²⁻) with a concentration of 10 mM to maximum soluble concentration. Accordingly, an ion exchange resin media containing unwanted cations or anions may be conditioned to remove the unwanted cations or anions and replace them with K⁺ and/or CO₃²⁻.

In some embodiments, the conditioning using the desired electrolyte can either be done in a single pass or recirculated to achieve equilibrium. The conditioning electrolyte can be replaced with a fresh electrolyte once or more to ensure that unwanted exchange ions are thoroughly replaced with desired exchange ions. Each cycle can be for a few seconds, minutes, hours, or days to ensure thorough conditioning of the resin.

### Regeneration of Soluble Solute(s) Filter:

The soluble solute(s) filter described herein will selectively bind to ionic impurities and maintain the desired process water composition. Over time, the filter media will get fully saturated with the soluble solute(s) impurities. Once the filter media saturates, they will no longer absorb further impurities contained in feed water or generated by cell operation. After saturation, either the media needs to be completely discarded and replaced with fresh media, or the media needs to be regenerated for reuse and to extend its utility/lifetime before disposal. In some embodiments of the present application, the media saturated with impurities may be regenerated by conditioning using the procedure described in FIG. 9. The desired exchange ions from the electrolyte (A⁺B⁻) will replace the impurities that have saturated the resin media. In a preferred embodiment, the electrolyte is K₂CO₃ (K⁺ & CO₃²⁻) with a concentration of 10 mM to maximum soluble concentration. The regeneration using the desired electrolyte can either be done in a single pass or recirculated to achieve equilibrium. The regeneration electrolyte can be replaced with a fresh electrolyte once or more to ensure that unwanted exchange ions are thoroughly replaced with desired exchange ions. Each cycle can last for a few seconds, minutes, hours, or days to ensure thorough replacement of the bound impurities of the resin.

### Disposal of Hazardous Impurities

In some embodiments, the soluble solute(s) filter will bind hazardous materials, for example hexavalent chromium ([CrO₄]²⁻, [Cr₂O₇]²⁻) ions. Hexavalent chromium is an occupational hazard and also can be environmentally hazardous. Therefore, Cr(VI) needs to be reduced to Cr(III). In one embodiment, this can be achieved by using hydrometallurgical reduction by using reducing agents such as ferrous sulfate, sulfur dioxide, or sodium bisulfate. In another embodiment, sodium borohydride and sodium borate solutions are used. In a preferred embodiment, the reduction is carried out by flowing water containing Cr(VI) into a filter cartridge with an ion exchange resin media conditioned with a borohydride solution. The borohydride will reduce the Cr(VI) to Cr(OH)₃ which is environmentally benign to dispose.

### Recovering Decayed Device Efficiency:

In another aspect, the present application provides approaches for recovering decayed device efficiency based on accumulation of impurities or other cumulative impact of impurities on electrolyzer performance. Electrochemical device efficiency generally decreases over time based on impurities in the process water.

In one embodiment, device efficiency is recovered by lowering the current density of a stack of electrochemical devices for a predefined time period and then increasing it back to higher values. Preferably, the current density is lowered to between the original operating current density (e.g. 0.75 to 2 A/cm²) and 0 A/cm². The period could be anywhere between 1 s to 24 hours. The period could also be 1 to several days. This protocol may optionally be periodic, e.g. once every hour, day or week, or month, or year(s) etc. While this protocol is employed the water flow may be brought down to 0 sccm or may not be changed at all.

In another embodiment, device efficiency is recovered by flowing fluids in the electrochemical device for a period that reverse the deposition of impurities onto the cell or non-cell components within the stack. In one embodiment, the fluid is de-ionized water. In another embodiment, the fluid is an anti-foulant or anti-scalant, such as NaOCl, oxalic acid, acetic acid, formaldehyde, sulfite solutions, sodium hexametaphosphate, sodium metabisulfate and/or some different electrolyte concentrations. The current may or may not be on while flowing these fluids through the lines. The period could be anywhere between a few seconds, minutes, hours, days, or months. The concentrations could be in the order of a few μM, mM, M.

One of ordinary skill in the art will recognize the approaches discussed herein may be used in insolation or combination.

The foregoing description of preferred embodiments has been presented for purposes of illustration and description only. It is not intended to be exhaustive or to limit the application to the precise form disclosed, and modifications and variations are possible and/or would be apparent in light of the above teachings or may be acquired from the practice of the application. The embodiments were chosen and described in order to explain the principles of the application and its practical application to enable one skilled in the art to utilize the application in various embodiments and with various modifications as are suited to the particular use contemplated. It is intended that the scope of the application be defined by the claims appended hereto and that the claims encompass all embodiments of the application, including the disclosed embodiments and their equivalents.

### EXAMPLES

### Example 1

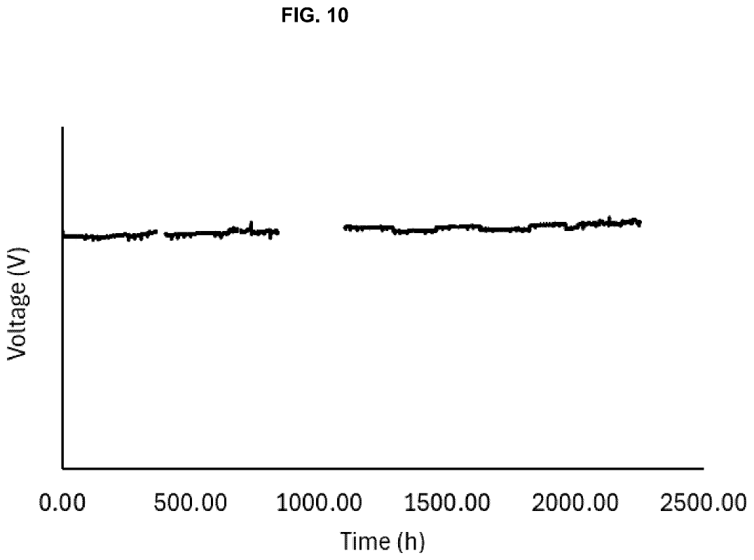

An electrolyzer stack containing 4 cells was assembled. The cells have an active area of 12.6 cm². An electrolyte solution of 10 mM K₂CO₃ was prepared by adding the appropriate amount of 1 M K₂CO₃ into a gallon of water. The water was sourced entirely from tap water with in-line sediment and chloramine filters to remove suspended solids and organics. The source bottle was connected to the inlet and outlet of the stack. The water from the stack outlet flew through an ion exchange filter (400 g of mixed bed resin) before returning to the source electrolyte bottle. A secondary loop treats the water using a ferric oxide-containing filter followed by a sediment filter. After the circulating water in the primary and secondary loop is sufficiently heated via a heat exchanger to deliver a temperature of 65° C. within the cells, the stack's current density increases from 0 A/cm² to 0.75 A/cm². The cell voltage equilibrates at a value, and the stack is reasonably operational for 2000+h. The average of cell voltages as a function of time is shown IN FIG. 10.

### Example 2

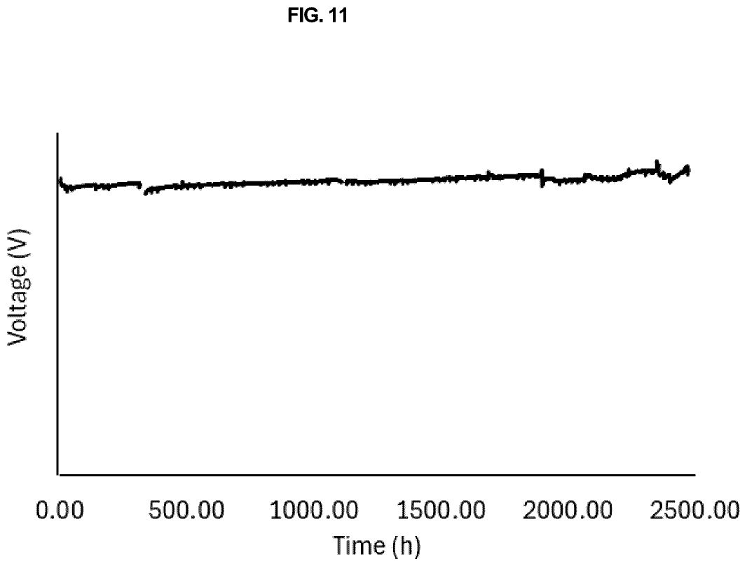

An electrolyzer stack containing 4 cells was assembled. The cells have an active area of 12.6 cm². An electrolyte solution of 10 mM K₂CO₃ was prepared by adding the appropriate amount of 1 M K₂CO₃ into a gallon of water. The water was sourced entirely from ASTM Type 1 DI water. The source bottle was connected to the inlet and outlet of the stack. The water from the stack outlet flew through an ion exchange filter (400 g of mixed bed resin) before returning to the source electrolyte bottle. A secondary loop treats the water using a ferric oxide-containing filter followed by a sediment filter. After the circulating water in the primary and secondary loop is sufficiently heated to deliver a temperature of 65° C. within the cells, the stack's current density increases from 0 A/cm² to 0.75 A/cm². The cell voltage equilibrates at a value, and the stack is reasonably operational for 2000+h. The average of cell voltages as a function of time is shown in FIG. 11.

### Example 3

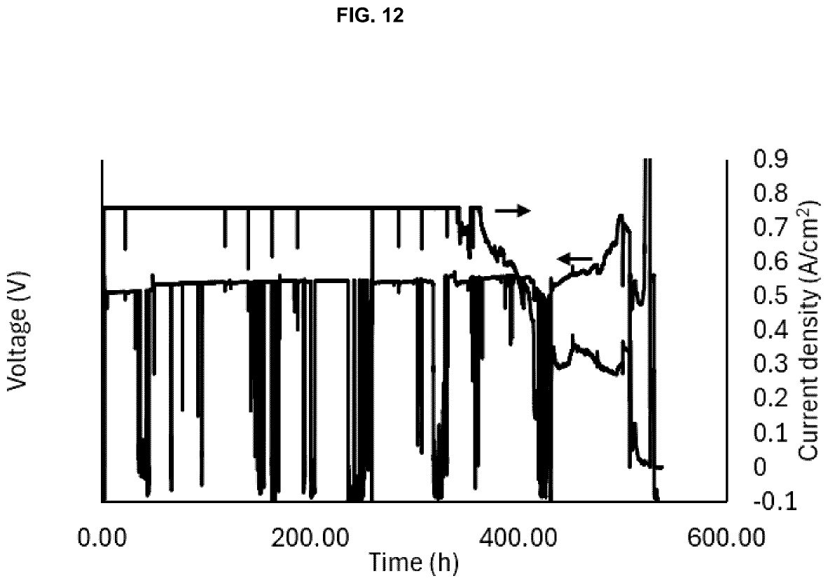

An electrolyzer stack containing 4 cells was assembled. The cells have an active area of 12.6 cm². An electrolyte solution of 10 mM K₂CO₃ was prepared by adding the appropriate amount of 1 M K₂CO₃ into a gallon of water. The water was sourced entirely from ASTM Type 1 DI water. The source bottle was connected to the inlet and outlet of the stack. There were no in-line filters connected to the stack. There was no secondary filter connected to the stack. After the circulating water is sufficiently heated to deliver a temperature of 65° C. within the cells, the stack's current density increases from 0 A/cm² to 0.75 A/cm². After a stable operation for a day, an appropriate amount of Mg, Ca, and Si was added to the source bottle to achieve 65, 4, and 100 ppm of Mg, Ca, and Si. The cell becomes inefficient as the voltages start increasing due to fouling. Then, eventually, the current starts dropping below the desired current density of 0.75 A/cm². The average of cell voltages as a function of time is shown in FIG. 12.

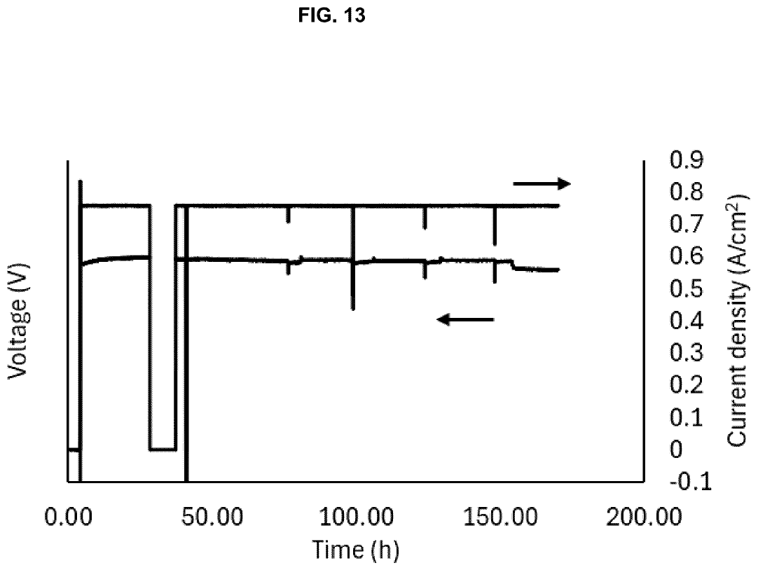

After the current density was almost negligible, the power was turned off, and the stack was rinsed in Type 1 DI water for a suitable time. Then, the stack efficiency was revived by flowing 2 liters of 0.2 M oxalic acid overnight with no applied voltage. Later, the source bottle was switched to fresh 10 mM K₂CO₃ made from Type 1 DI water. The water was heated back to achieve 65° C. in the cells, and the current density was ramped up from 0 to 0.75 A/cm². As shown in FIG. 13, the degraded stack was recovered, suggesting a reversal of fouling.

### Further Embodiments

1 An impurity removal system for process water for an electrolytic cell.
1.1 The impurity removal system of 1, comprising an insoluble solids filter or a soluble solute(s) filter.
1.2 The impurity removal system of 1, comprising both an insoluble solids filter and a soluble solute(s) filter.
1.3 The impurity removal system of 1.1 or 1.2, wherein the insoluble solids filter is a size exclusion filter.
1.4 The impurity removal system of 1.3, wherein the size exclusion filter comprises a filter media selected from the group consisting of mesh, foam, paper, packed media, and resin.
1.5 The impurity removal system of 1.4, wherein the filter media comprises a metallic, polymeric, or ceramic material.
1.6 The impurity removal system of 1.4, wherein the size exclusion filter comprises a housing material resistant to alkaline chemicals.
1.7 The impurity removal system of 1.6, wherein the housing material comprises polypropylene.
1.8 The impurity removal system of 1.1 or 1.2, wherein the soluble solute(s) filter comprises a filter media comprising an ion exchange resin.
1.9 The impurity removal system of 1.8, wherein the ion exchange resin comprises a polymeric salt having fixed cationic side chains or fixed anionic side chains.
1.10 The impurity removal system of 1.9, wherein the ion exchange resin comprises a polymeric salt having fixed cationic side chains and fixed anionic side chains.
1.11 The impurity removal system of 1.10, wherein the ion exchange resin has a ratio (m) of anionic to cationic exchange resin mass between 0 to 1.
1.12 The impurity removal system of 1.10, wherein the ion exchange resin is capable of binding cationic impurities and anionic impurities.
1.13 The impurity removal system of 1.10, wherein the ion exchange resin is capable of binding cationic impurities and anionic impurities and releasing ions associated with an electrolyte in the process water.
1.14 The impurity removal system of 1.10, wherein the ion exchange resin selectively binds hexavalent chromium.
1.15 The impurity removal system of 1.14, wherein the ion exchange resin is conditioned with borohydride solution, wherein the borohydride solution reduces Cr(VI) to Cr(III).
1.16 The impurity removal system of 1.8, wherein the soluble solute(s) filter comprises an adsorption media.
1.17 The impurity removal system of 1.8, wherein the soluble solute(s) filter comprises a housing material resistant to alkaline chemicals.
1.18 The impurity removal system of 1.16, wherein the housing material comprises polypropylene.
2 An electrolysis system comprising a water electrolyzer and an impurity removal system of any of 1 to 1.17.
2.1 The electrolysis system of 2, wherein the water electrolyzer is an AEMEL.
2.2 The electrolysis system of 2.1, wherein the impurity removal system is arranged upstream of the water electrolyzer.
2.3 The electrolysis system of 2.1, wherein the impurity removal system is arranged downstream of the water electrolyzer.
3 A method of removing impurities from process water of a water electrolyzer.
3.1 The method of 3, comprising
   providing an impurity removal system of any of 1 to 1.17, and
   flowing process water through the removal system.
4 A method of recovering cell efficiency of an electrolytic cell.
4.1 The method of 4, comprising
   reducing the current density in the electrolytic cell for a duration of 1 second to 24 hours.
4.2 The method of 4.1, wherein the current density is repeatedly reduced periodically, wherein the period is 1 to 10 days.
4.3 The method of 4, comprising flowing a recovery fluid through the cell.
4.4 The method of 4.3, wherein the recovery fluid is selected from the group consisting of deionized water, anti-foulants, anti-scalants, and combinations thereof.
5 A system for conditioning a resin media.
5.1 The system of 5, comprising a soluble solute(s) filter containing the resin media, wherein the resin media contains a plurality of first exchange ions.
5.2 The system of 5.1, further comprising a source of second exchange ions, wherein the source of second exchange ions is fluidly connected with the filter containing the resin media and is configured to flow the second exchange ions through the resin media to substantially replace the first exchange ions with the second exchange ions.
6 A method for conditioning resin media.
6.1 The method of 6, comprising providing a system of 5 to 5.2.
6.2 The method of 6.1, comprising flowing water containing the second exchange ions through the resin media until the second exchange ions substantially replace the first exchange ions in the resin media.
6.3 The method of 6.2, comprising flowing water containing the second exchange ions through the resin media until the ratio of second exchange ions to first exchange ions is at least 9:1, 95:5, or 99:1.

1. An impurity removal system for process water for an electrolytic cell.

2. The impurity removal system of claim 1, comprising an insoluble solids filter or a soluble solute(s) filter.

3. The impurity removal system of claim 1, comprising both an insoluble solids filter and a soluble solute(s) filter.

4. The impurity removal system of claim 2, wherein the insoluble solids filter is a size exclusion filter.

5. The impurity removal system of claim 4, wherein the size exclusion filter comprises a filter media selected from the group consisting of mesh, foam, paper, packed media, and resin.

6. The impurity removal system of claim 5, wherein the filter media comprises a metallic, polymeric, or ceramic material.

7. The impurity removal system of claim 5, wherein the size exclusion filter comprises a housing material resistant to alkaline chemicals.

8. The impurity removal system of claim 7, wherein the housing material comprises polypropylene.

9. The impurity removal system of claim 2, wherein the soluble solute(s) filter comprises a filter media comprising an ion exchange resin.

10. The impurity removal system of claim 9, wherein the ion exchange resin comprises a polymeric salt having fixed cationic side chains or fixed anionic side chains.

11. The impurity removal system of claim 10 wherein the ion exchange resin comprises a polymeric salt having fixed cationic side chains and fixed anionic side chains.

12. The impurity removal system of claim 11, wherein the ion exchange resin has a ratio (m) of anionic to cationic exchange resin mass between 0 to 1.

13. The impurity removal system of claim 11, wherein the ion exchange resin is capable of binding cationic impurities and anionic impurities.

14. The impurity removal system of claim 11, wherein the ion exchange resin is capable of binding cationic impurities and anionic impurities and releasing ions associated with an electrolyte in the process water.

15. The impurity removal system of claim 11, wherein the ion exchange resin selectively binds hexavalent chromium.

16. The impurity removal system of claim 15, wherein the ion exchange resin is conditioned with borohydride solution, wherein the borohydride solution reduces Cr(VI) to Cr(III).

17. The impurity removal system of claim 9, wherein the soluble solute(s) filter comprises an adsorption media.

18. The impurity removal system of claim 9, wherein the soluble solute(s) filter comprises a housing material resistant to alkaline chemicals.

19. The impurity removal system of claim 18, wherein the housing material comprises polypropylene.

20. A system for conditioning a resin media, comprising
a soluble solute(s) filter containing the resin media, wherein the resin media contains a plurality of first exchange ions;
a source of second exchange ions, wherein the source of second exchange ions is fluidly connected with the filter containing the resin media and is configured to flow the second exchange ions through the resin media to substantially replace the first exchange ions with the second exchange ions.

21. A method for conditioning resin media, comprising
providing the system of claim 20,
flowing water containing the second exchange ions through the resin media until the second exchange ions substantially replace the first exchange ions in the resin media.

22. The method of claim 21, further comprising flowing water containing the second exchange ions through the resin media until the ratio of second exchange ions to first exchange ions is at least 9:1, 95:5, or 99:1.

23. A method for regenerating a fully or partially saturated resin media in soluble solute(s) filter containing unwanted exchange ions, comprising
providing the system of claim 20;
flowing water containing a desired electrolyte through the resin media until the desired electrolyte substantially replaces the unwanted impurity ions.

24. A system for reducing Cr(VI) to Cr(III), comprising
a soluble solute(s) filter containing a resin media, wherein the resin media contains Cr(VI);
a source of reducing agent, wherein the reducing agent is hydrometallurgical to reduce Cr(VI) to Cr(III).

25. The system of claim 24, wherein the source of reducing agent is fluidly connected with the filter containing the resin media and is configured to flow the reducing agent through the resin media to reduce Cr(VI) to Cr(III).

26. The system of claim 24, wherein the source of reducing agent is a borohydride-conditioned ion-exchange resin, wherein the resin media comprises the borohydride-conditioned ion-exchange resin.

27. A method of operating an electrochemical cell or stack of electromechanical cells, comprising
operating the cell or stack at a first current density;
reducing the current density for 1 second to 24 hours.

28. The method of claim 27, wherein the step of reducing the current density is performed periodically, wherein the period is 1 to 5 days.

29. The method of claim 28, wherein the period is regular or irregular.

30. The method of claim 28, wherein the step of reducing the current density is performed whenever a predefined parameter is observed.

31. The method of claim 30, wherein the predefined parameter is selected from a reduction in efficiency of the cell or stack, an amount of impurities in process water exceeding a predefined level, or a combination thereof.

32. A method of recovering efficiency of an electrochemical cell or stack of electromechanical cells, comprising flowing a solution through the stack for a period.

33. The method of claim 32, wherein the solution is selected de-ionized water, anti-foulants, anti-scalants, and combinations thereof.
